(19) United States
(12) Patent Application Publication
(10) Pub. No.: US 2005/0191423 A1
(43) Pub. Date: Sep. 1, 2005

(54) Method of applying silicone caulking compound

(76) Inventors: Donald Ervin Steinwandt, Edmonton (CA); John Ruben Johnson, Sherwood Park (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/712,667

(22) Filed: Nov. 13, 2003

(30) Foreign Application Priority Data
Nov. 15, 2002 (CA) 2,411,939

(51) Int. Cl. B05D 3/10

(52) U.S. Cl. 427/337

(57) ABSTRACT

A method of applying a silicone caulking compound. A first step involves applying a bead of silicone caulking compound to a seam or surface. A second step involves spraying a cationic surfactant on the bead of silicone caulking compound. A third step involves wiping excess silicone caulking compound from the surface. The cationic surfactant applied to the surface “lubricates” the surface to prevent adhesion of the silicone caulking compound to the surface when excess material is wiped away, thereby preventing smearing.

### FIELD OF THE INVENTION

The present invention relates to method of applying a silicone caulking compound

### BACKGROUND OF THE INVENTION

The very properties which make silicone caulking compounds effective for caulking, make them difficult to apply with an attractive desired result. As silicone caulking compounds are tacky, they tend to stick to a surface. This property helps make an effective moisture seal. However, this same property tends to result in the silicone caulking compound being smeared over the seam or the sealing surface leaving a cosmetically unattractive finish.

### SUMMARY OF THE INVENTION

What is required is a simpler method of applying silicone caulking compound to obtain a cosmetically attractive finish.

According to the present invention there is provided a method of applying a silicone caulking compound. A first step involves applying a bead of silicone caulking compound to a surface. A second step involves spraying a cationic surfactant on the bead of silicone caulking compound. A third step involves wiping excess silicone caulking compound from the surface. The cationic surfactant applied to the surface “lubricates” the surface to prevent adhesion of the silicone caulking compound to the undesired surface areas when excess material is wiped away, thereby preventing smearing.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a method applying silicone caulking compound to a surface according to the teachings of the preferred method.

FIG. 2 is a perspective view of the method illustrated in FIG. 1, wherein a cationic surfactant is sprayed on silicone caulking compound.

FIG. 3 is a perspective view of the method illustrated in FIG. 1, wherein excess silicone caulking compound is wiped from a surface.

### DETAILED DESCRIPTION OF THE PREFERRED EMBODIMENT

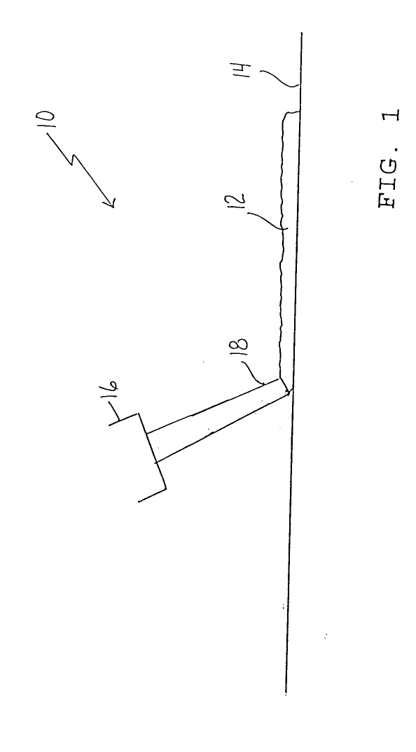

The preferred method will now be described with reference to FIGS. 1 through 3. Referring to FIG. 1, there is illustrated a method of applying a silicone caulking compound 10 which includes applying a bead of silicone caulking compound 12 to a surface 14. Surface 14 to which silicone caulking compound 12 is to be applied should be smooth, dry, and free of all debris, including any previous caulking prior before the application of silicone caulking compound 12. In the illustrated method 10, a caulking tube 16 with an application tip 18 is used for applying bead of silicone caulking compound 12, however it will be appreciated that a caulking gun could also be used.

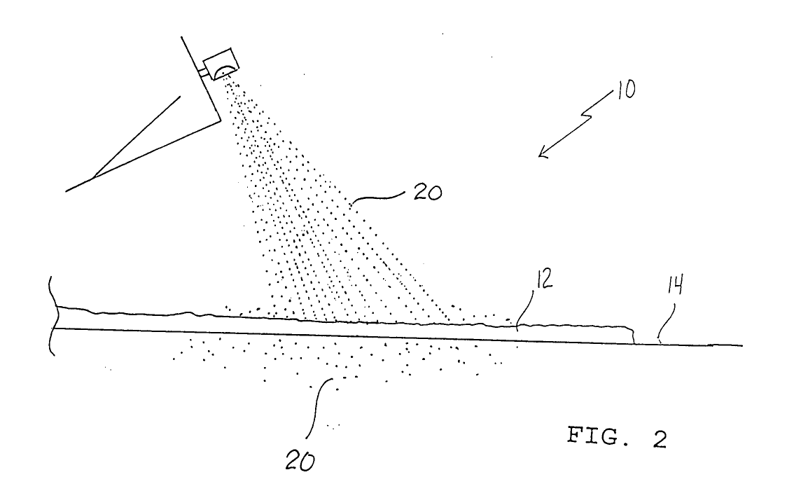

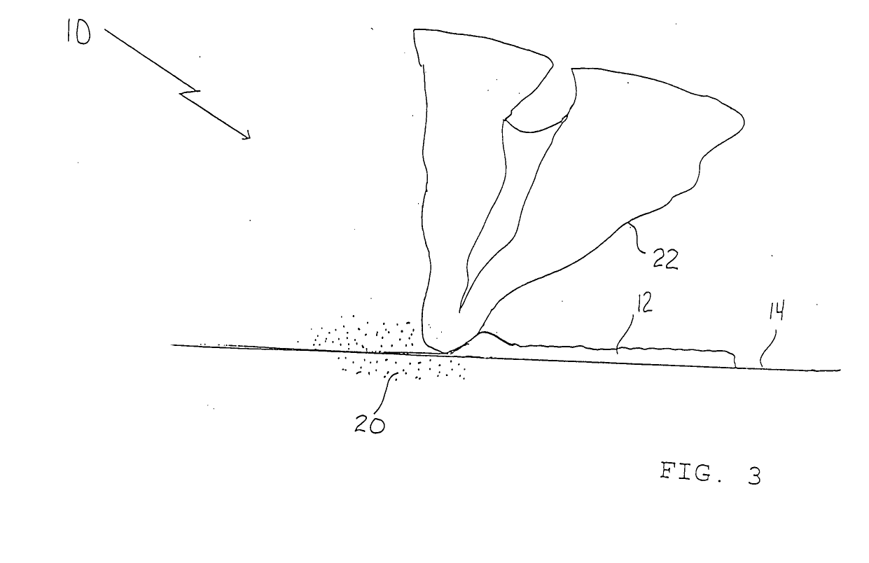

Referring to FIG. 2, a cationic surfactant 20 is sprayed on bead of silicone caulking compound 12 before bead of silicone caulking compound 12 begins to set. Referring to FIG. 3, after silicone caulking compound 12 has been sprayed with cationic surfactant 20, excess silicone caulking compound 12 is wiped from surface 14. In illustrated method, a cloth 22 is used to wipe excess silicone caulking compound 12, however it will be appreciated that one could use a finger or other means could be used. It will also be appreciated that if silicone caulking compound is to be applied to a seam between two or more surfaces 14, then bead of silicone caulking compound 12 must come into contact with all of surfaces 14. No further silicone caulking compound 12 may be added after the spraying of cationic surfactant 20. Silicone caulking compound 12 is then allowed to set for a period of 4 to 10 hours.

Use

The use of the method of applying a silicone caulking will now be described with reference to FIGS. 1 through 3. Referring to FIG. 2, with the method described above, cationic surfactant 20 that is applied to surface 14 “lubricates” surface 14 to prevent adhesion of silicone caulking compound 12 to surface 14. Referring to FIG. 3, excess silicone caulking compound 12 may then be wiped away. Spreading out or smearing is prevented as silicone caulking compound 12 cannot adhere to surface 14 after it has been sprayed with cationic surfactant 20. It will be appreciated that a finger or other wiping device could also be used to wipe excess silicone caulking compound 12. The excess silicone that is removed is not sticky or tacky and can be readily transferred, without mess, to a rag or paper towel for disposal.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method of applying a silicone caulking compound, comprising the steps of:
applying a bead of silicone caulking compound to a surface;
spraying a cationic surfactant on the bead of silicone caulking compound before the bead of silicone begins to set; and
wiping excess silicone caulking compound from the surface, the cationic surfactant lubricating the surface to prevent smearing of the silicone caulking compound.

2. A method of applying a silicone caulking compound to a surface and preventing undesired adhesion of the silicone caulking compound to areas of the surface adjacent the silicone caulking compound, the method comprising the steps of:
applying a bead of silicone caulking compound to the surface;
applying a cationic surfactant to the bead of silicone caulking compound and areas of the surface adjacent the bead of silicone caulking compound before the bead of silicone begins to set; and
following application of the cationic surfactant, wiping excess silicone caulking compound from the surface, whereby the cationic surfactant functions as a surface lubricant and prevents adhesion of the silicone caulking compound to the undesired areas of the surface.

3. A method of applying a silicone caulking compound to a dry surface and preventing undesired adhesion of the silicone caulking compound to areas of the dry surface adjacent the silicone caulking compound, the method comprising the steps of:
freeing the dry surface of any debris prior to applying the silicone caulking compound;
applying a bead of silicone caulking compound to the dry surface;
applying a cationic surfactant to the bead of silicone caulking compound and areas of the dry surface adjacent the bead of silicone caulking compound before the bead of silicone begins to set; and
following application of the cationic surfactant, wiping excess silicone caulking compound from the dry surface, whereby the cationic surfactant functions as a surface lubricant and prevents adhesion of the silicone caulking compound to the undesired areas of the dry surface; and
allowing the silicone caulking compound to set on the dry surface for at least four hours.
